(19) United States
(12) Patent Application Publication
(10) Pub. No.: US 2026/0169460 A1
(43) Pub. Date: Jun. 18, 2026

(54) INFORMATION PROCESSING DEVICE, AND COMPUTER-READABLE STORAGE MEDIUM

(71) Applicant: Fanuc Corporation, Minamitsuru-gun, Yamanashi (JP)

(72) Inventor: Takashi MIYOSHI, Minamitsuru-gun, Yamanashi (JP)

(73) Assignee: Fanuc Corporation, Minamitsuru-gun, Yamanashi (JP)

(21) Appl. No.: 18/710,490

(22) PCT Filed: Nov. 24, 2021
(86) PCT No.: PCT/JP2021/042923

§ 371 Date: May 15, 2024

(51) Int. Cl. G05B 19/4155; G06Q 30/04

(52) U.S. Cl. CPC G05B 19/4155; G06Q 30/04

(57) ABSTRACT

An information processing device for calculating the amount of usage of a system program that converts a machining program into a control signal for a machine tool determines whether or not the machining program includes fee-based codes, determines whether or not machining is executed based on the tool state of the machine tool executing the machining program, and calculates the amount of usage of the fee-based codes when the fee-based codes are executed.

### CROSS REFERENCE TO RELATED APPLICATIONS

This is the U.S. National Phase application of PCT/JP2021 /042923, filed Nov. 24, 2021, the disclosure of this application being incorporated herein by reference in its entirety for all purposes.

### FIELD OF THE INVENTION

The present invention relates to an information processing device and a computer-readable storage medium.

### BACKGROUND OF THE INVENTION

Machine tools have built-in servo motors. A servo motor constitutes a set servo system together with a servo driver. A numerical controller stores machining programs and system programs. A machining program is mainly composed of strings of alphabetic and numeric characters, and tool coordinates and movement commands are written therein. A system program generates signals based on the commands in the machining program to thereby control the servo system according to the description of the machining program.

Some system programs for numerical controllers are adapted to billing systems. A billing system stores a basic system program and optional system programs in a numerical controller and charges for the optional system program.

In the billing system, there is a desire to pay for optional programs only for what are used. To satisfy this desire, Patent Literature 1 discloses a usage management system that “has optional functions and includes a plurality of numerical controllers for controlling machines based on machining programs and a management unit for managing usage of the optional functions for each of the plurality of numerical controllers, each numerical controller detecting the number of times the optional functions are used to generate information about the usage of the optional functions”.

### PRIOR ART DOCUMENT

### Patent Literature [Patent Literature 1] Japanese Patent Laid-Open Publication No. 2016-81469

### SUMMARY OF THE INVENTION

In a case of calculating an amount of usage of an optional program based on the machining program as disclosed in Patent Literature 1, there may be a difference between the calculated amount and an actual amount of usage.

In the billing system for the numerical controller, a technique for calculating the amount of usage to be charged is desired.

An aspect of the present disclosure is an information processing device that is for calculating an amount of usage of a system program for converting a machining program into control signals for a machine tool, including: an effective block determination unit that determines whether or not there is a code to be charged in the machining program; a machining state determination unit that determines whether or not the machining is being executed based on a machine state of the machine tool when the machining program is executed; and a usage amount calculation unit that calculates an amount of usage of the code to be charged when the code to be charged is being executed.

An aspect of the present disclosure is a storage medium that is for storing commands which are readable by one or more processors, wherein the one or more processors conducts the commands to: determine whether or not there is a code to be charged in a machining program for a machine tool; execute the machining program; determine whether or not machining is being executed based on a machine state of the machine tool when the machining program is executed; and calculate an amount of usage of the code to be charged when the code to be charged is being executed.

One aspect of the present invention can calculate the amount of usage to be charged.

### BRIEF DESCRIPTION OF THE DRAWINGS

FIG. 1 is a block diagram of a numerical controller according to a first disclosure;

FIG. 2 shows an example of a machining program;

FIG. 3 shows a configuration of a system program;

FIG. 4 shows an example of data stored in a selection option storage unit; FIG. 5A shows an example of a price list (billing fee per used hour);

FIG. 5B shows another example of the price list (billing fee per number of usages);

FIG. 6 is a flowchart illustrating processing performed in the numerical controller of the first disclosure;

FIG. 7 is a block diagram of a numerical controller according to a second disclosure;

FIG. 8 is a flowchart illustrating processing performed in the numerical controller of the second disclosure; and

FIG. 9 shows a hardware configuration of the numerical controller.

### MODE FOR CARRYING THE INVENTION

### First Disclosure

A description will now be made about a numerical controller 100 according to a first disclosure.

The first disclosure describes about the numerical controller 100 as an example of an information processing device. The information processing device can be applied to information processing devices other than the numerical controller, such as a personal computer (PC) and a server, if there is a function of converting a machining program into control signals for a machine tool.

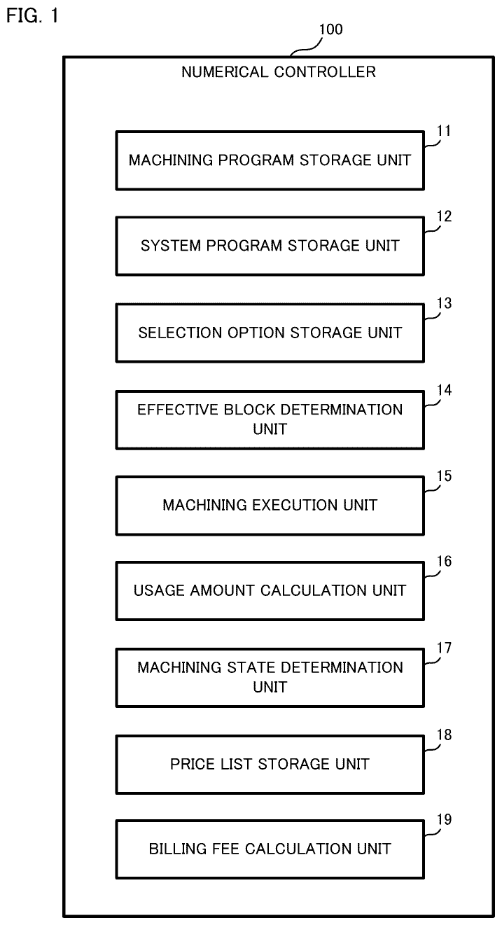

FIG. 1 is a block diagram of the numerical controller 100. The numerical controller 100 includes a machining program storage unit 11, a system program storage unit 12, a selection option storage unit 13, an effective block determination unit 14, a machining execution unit 15, a usage amount calculation unit 16, a machining state determination unit 17, a price list storage unit 18 and a billing fee calculation unit 19.

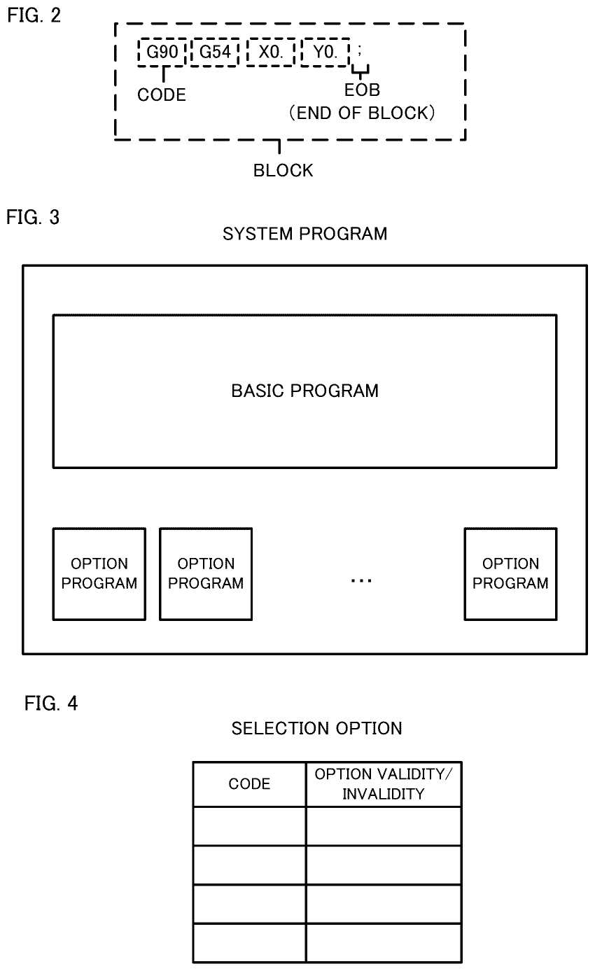

The machining program storage unit 11 is configured to store a machining program to be charged. FIG. 2 shows an example of the machining program. The machining program consists of a plurality of lines called blocks. The blocks include codes, such as G-codes and M-codes, that specify functions of a machine tool. By commanding the codes, internal settings for a numerical controller of the machine tool, such as axis movement, coordinate setting, rotation, target machining method for tools and others of the machine tool, can be made.

The system program storage unit 12 is configured to store a system program for converting the machining program into control signals for the machine tool. The system program consists of a basic program and optional programs, as shown in FIG. 3. The basic program can be used free of charge. The option programs are charged.

The numerical controller 100 is provided with various options. When a user enables an option, a code corresponding to the option and an option program for executing the code become available. The options include, for instance, tool tip point control, smooth transformer control and three-directional error compensation. The selection option storage unit 13 is configured to store validity/invalidity of the codes and the options. FIG. 4 shows an example of data stored in the selection option storage unit 13.

The effective block determination unit 14 is configured to determine whether or not any code to be charged exists in the machining program. More specifically, the effective block determination unit 14 analyzes the machining program to determine whether the codes to be charged included in the machining program are available (the options are valid).

The machining execution unit 15 is configured to analyze the machining program, generate an axis control signal, and output the control signal to a servo system. A servo motor of the machine tool drives a motor according to the control signal to thereby execute machining.

The machining state determination unit 17 is configured to determine whether or not the machining is being executed by using a cord to be charged based on the machine state set by the numerical controller 100.

There are two methods to determine whether the machining is being executed. The first method makes a determination from an operation mode. In a case where the operation mode is dry run, machine lock or the like, it is determined that the machining state is idle running and the machining is not executed.

The second method checks the actual machine motion. Contact between the tool and a workpiece can be determined based on, such as, spindle load, image recognition and the relative positional relationship between the tool and the workpiece. On the basis of these data, a billing determination unit determines whether or not the machine is actually doing the machining.

The usage amount calculation unit 16 is configured to calculate an amount of usage of the code to be charged. The amount of usage of the code is machining execution time or the number of machining executions, but is not limited thereto. The calculation may also be conducted on an amount of usage of a code which is not charged. By calculating the amounts of usage of various codes, differences in the amounts of usage for codes can be grasped.

The usage amount calculation unit 16 may register conditions that no charge is made even when the amount of usage is calculated. For example, the conditions that no charge is made even when the amount of usage is calculated include a defect in the machine, such as the machine tool or numerical controller 100, a power failure during operation, and so on. The usage amount calculation unit 16 does not add the amount of usage when the machining is interrupted under the registered conditions.

The usage amount calculation unit 16 records the amounts of usage of the codes. The recording of the amounts of usage allows the user to confirm his/her utilization track records, such as used hours of the codes and the number of times the codes are used.

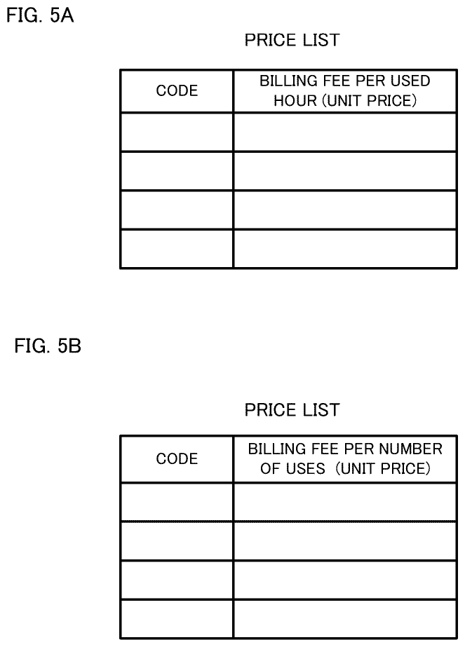

The billing fee calculation unit 19 is configured to calculate a billing fee based on the amount of usage of the code to be charged. The price list storage unit 18 is configured to record a unit price for the amount of usage of each code. FIG. 5 shows an example of a price list. FIG. 5A shows a price list that includes codes and billing fees (unit prices) per hour of use. FIG. 5B shows a price list that includes codes and billing fees (unit prices) per the number of uses.

The billing fee calculation unit 19 calculates the billing fees based on the amount of usage of the code to be charged, such as the machining execution time or the number of machining executions by this cord.

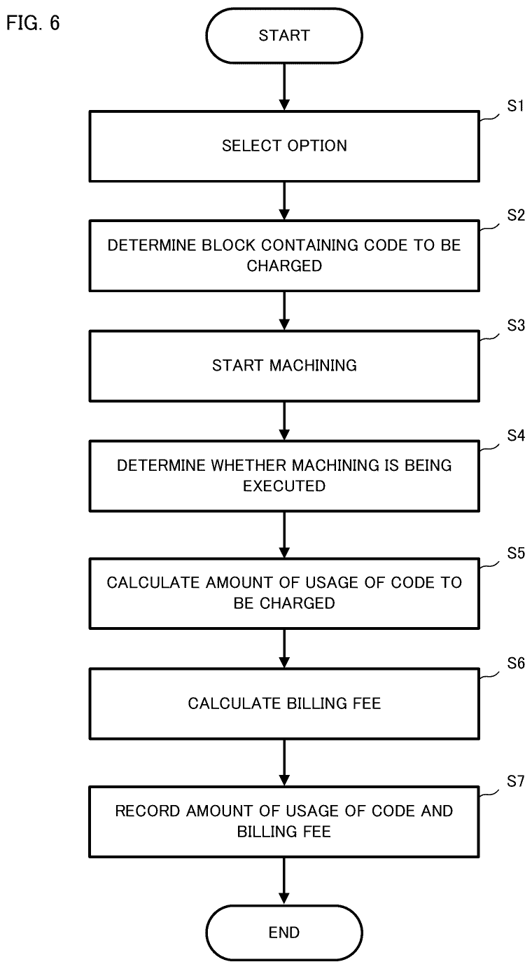

With reference to FIG. 6, a description will be made about the processing performed in the numerical controller 100 of the first disclosure.

The user of the numerical controller 100 selects an option to use (step S1). This enables a code corresponding to the selected option to be used.

The numerical controller 100 determines a block that contains a code to be charged (step S2).

The numerical controller 100 starts machining (step S3). The numerical controller 100 determines whether or not the machining is being executed (step S4). In a case where the machining is interrupted under the predefined conditions based on the operation mode, such as dry run or machine lock, spindle load, image recognition, the relative positional relationship between the tool and the workpiece, and the like, it is determined that the machining is not executed.

The numerical controller 100 calculates the amount of usage of the code to be charged (step S5). The amount of usage of the code includes the used hours of the code and the number of times the code is used.

The numerical controller 100 calculates the billing fees of each code based on the amount of usage of the code (step S6). The numerical controller 100 records the amount of usage of the code, such as the used hour or the number of times the code is used, and the billing fees of the code (step S7).

As described above, the numerical controller 100 searches for a block in which the code to be charged is written, and determines whether or not the machining is executed by the code to be charged to thereby calculate the amount of usage of the code. The numerical controller 100 of the first disclosure can acquire user's utilization track records, such as used hours of the options and the number of times the options are used and usage fees. In addition to that, the utilization track records can be utilized to improve service, create new options and so on.

According to the numerical controller 100 of the first disclosure, the user is charged only for the use of the codes, so that the burden of the billing fees on the user can be reduced. Furthermore, the user can confirm how much billing fees are incurred for any given block. The user can also select between usage-based billing and flat-rate billing depending on the frequency of use.

### Second Disclosure

A description will now be made about a numerical controller 100 according to a second disclosure.

The second disclosure describes about the numerical controller 100 as an example of an information processing device. The information processing device can be applied to information processing devices other than the numerical controller, such as a personal computer (PC) and a server, if there is a function of converting a machining program into control signals for a machine tool, the information processing devices being.

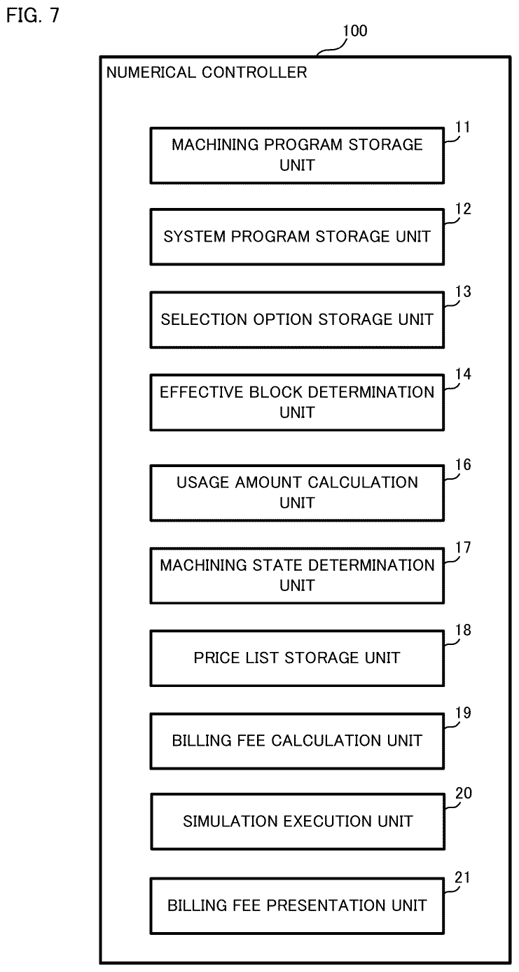

FIG. 7 is a block diagram of the numerical controller 100. The numerical controller 100 includes a machining program storage unit 11, a system program storage unit 12, a selection option storage unit 13, an effective block determination unit 14, a simulation execution unit 20, a usage amount calculation unit 16, a machining state determination unit 17, a price list storage unit 18, a billing fee calculation unit 19 and a billing fee presentation unit 21.

The numerical controller 100 of the second disclosure is configured to determine whether or not machining is executed through a simulation. Prior to the execution of the machining through the simulation, information about utilization track records on a system program can be determined. The information about utilization track records includes, but is not limited to, used hour, the number of times the program is used, billing fees and others.

In the description about the numerical controller 100 of the second disclosure, the same constituent elements as those in the numerical controller 100 of the first disclosure will not be described.

The machining program storage unit 11 is configured to store machining programs to be charged. The system program storage unit 12 is configured to store a system program for converting a machining program into control signals for a machine tool. The system program consists of a basic program and optional programs, as shown in FIG. 3. The basic program can be used free of charge. The option programs are charged.

The selection option storage unit 13 is configured to store a code to be charged which becomes available by a user selecting an option.

The effective block determination unit 14 is configured to determine whether or not any code to be charged exists in the machining program. More specifically, the effective block determination unit 14 analyzes the machining program to determine whether the codes to be charged included in the machining program are available (the options are valid).

The simulation execution unit 20 is configured to execute a simulation on the machining program.

Based on the simulation, the machining state determination unit 17 is configured to determine whether or not the machining is executed by using the cord to be charged.

There are two methods to determine whether the machining is being executed. The first method makes a determination from an operation mode. In a case where the operation mode is dry run, machine lock or the like, it is determined that the machining state is idle running and the machining is not executed.

The second method checks the actual machine motion. Contact between the tool and a workpiece can be determined based on, such as, a relative positional relationship between the tool and the workpiece. On the basis of these data, a billing determination unit determines whether or not the machine tool is actually doing the machining.

Calculation is performed on an amount of usage of the code, such as machining execution time or the number of machining executions. When the operation mode in the simulation is dry run or machine lock, for example, the machining state determination unit 17 determines that the machining is in idle running. Furthermore, the machining state determination unit 17 determines whether or not the machining is actually being executed based on the coordinate positions of a tool and a workpiece in the simulation.

The usage amount calculation unit 16 is configured to calculate an amount of usage of the code to be charged. The amount of usage of the code is machining execution time or the number of machining executions, but is not limited thereto. The calculation may also be conducted on an amount of usage of a code which is not charged. By calculating the amounts of usage of various codes, differences in the amounts of usage for codes can be grasped.

The usage amount calculation unit 16 records the amounts of usage of the codes. The recording of the amounts of usage allows the user to confirm his/her utilization track records, such as used hours of the codes and the number of times the codes are used.

The billing fee calculation unit 19 is configured to calculate a billing fee based on the amount of usage of the code to be charged. The price list storage unit 18 is configured to record a unit price for the amount of usage of each code. The billing fee calculation unit 19 calculates the billing fee based on the amount of usage, such as the used hours of the code or the number of times the cord is used.

The billing fee presentation unit 21 is configured to present to the user the billing fees calculated by the billing fee calculation unit 19. The user can refer to the billing fees to determine which option should be selected and which code should be used.

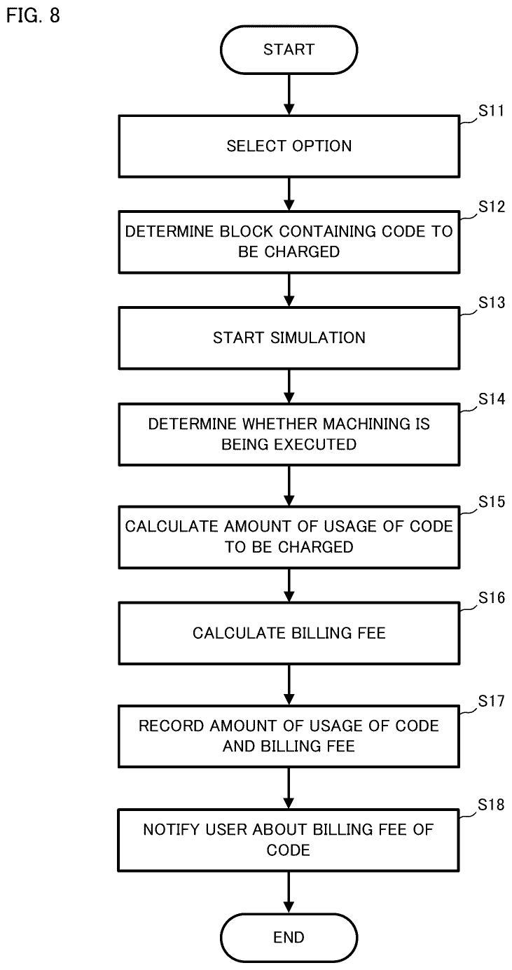

With reference to FIG. 8, a description will be made about the processing performed in the numerical controller 100 of the second disclosure.

The user of the numerical controller 100 selects an option to use (step S11). This enables a code corresponding to the selected option to be used.

The numerical controller 100 determines whether there is a block that contains a code to be charged (step S12).

The numerical controller 100 starts simulation (step S13). The numerical controller 100 determines whether or not the machining is executed by using the code to be charged (step S14). The determination is based on an operation mode and the coordinate positions of a tool and a workpiece in the simulation.

The numerical controller 100 calculates the amount of usage of the code to be charged (step S15). The amount of usage of the code includes the used hours of the code and the number of times the code is used.

The numerical controller 100 calculates the billing fee of each code based on the amount of usage of the code (step S16). The numerical controller 100 records the amount of usage of the code, such as the used hours or the number of times the code is used, and the billing fees of the code (step S17).

The numerical controller 100 notifies the user about the billing fee for the code based on the simulation (step S18). The user confirms the billing fee based on the simulation and decides whether to use the code.

As described above, the numerical controller 100 of the second disclosure searches for a block in which the code to be charged is written, and conducts the simulation on the machining program. The amount of usage of the code to be charged is calculated during the simulation. The numerical controller 100 of the second disclosure enables the user to confirm his/her utilization track records, such as used hours of the code, the number of times the code is used and a usage fee of the code. In addition to that, the utilization track records can be utilized to improve service, create new options and so on.

According to the numerical controller 100 of the second disclosure, since the billing fee is calculated during simulation, the user can check the billing fee before executing machining. After checking the billing fee, the user can take an action, such as rewriting of the machining program. Furthermore, the user can check how much fees will be charged for which blocks. The user can also select between usage-based billing and flat-rate billing depending on the frequency of use.

### Hardware Configuration

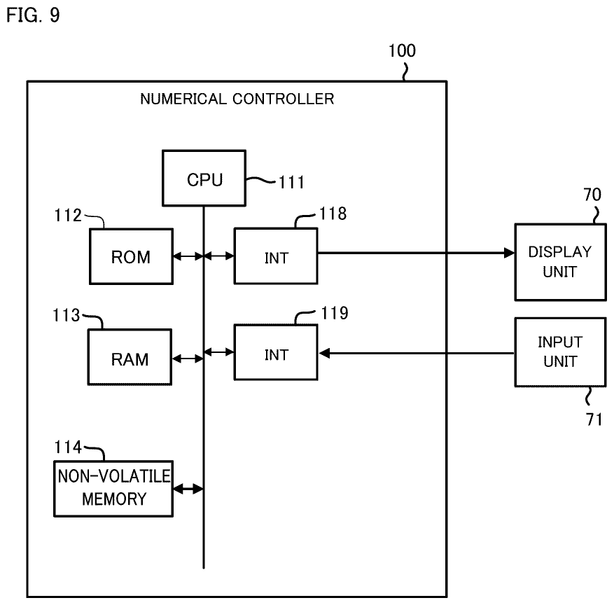

A hardware configuration of the numerical controller 100 will be described by referring to FIG. 9. The numerical controller 100 includes a central processing unit (CPU) 111 that is a processor for controlling the entire numerical controller 100. The CPU is configured to read a system program processed by a read-only memory (ROM) 112 through a bus to thereby control the entire numerical controller 100 in accordance with the system program. A random-access memory (RAM) 113 is configured to temporarily store temporary calculation data and pieces of data to be displayed, as well as various data input by a user through an input unit 71.

A display unit 70 is a monitor or similar that is attached to the numerical controller 100. The display unit 70 is configured to display such as an operation screen and a setting screen of the numerical controller 100.

The input unit 71 is a keyboard, touch panel or similar that is integral with or separated from the display unit 70. The user operates the input unit 71 to input data to a screen displayed on the display unit 70, for instance. The display unit 70 and the input unit 71 may be handheld devices.

A non-volatile memory 114 is, for example, a memory that is backed up by a battery, not shown, so that a state of storage is retained even when a power source of the numerical controller 100 is turned off. The non-volatile memory 114 is configured to store a machining program, a system program, available options, a price list and the like. The non-volatile memory 114 stores programs read from an external device via an interface, not shown, programs input through the input device 71, and various data acquired from the units of the numerical controller 100, machine tools and others (e.g., setting parameters acquired from the machine tools). The programs and the various data stored in the non-volatile memory 114 may be stored in the RAM 113 when they are executed/used. Furthermore, the ROM 112 is configured to store various system programs in advance.

### REFERENCE SIGNS LIST

100 Numerical Controller
11 Machining Program Storage Unit
12 System Program Storage Unit
13 Selection Option Storage Unit
14 Effective Block Determination Unit
15 Machining Execution Unit
16 Usage Amount Calculation Unit
17 Machining State Determination Unit
18 Price List Storage Unit
19 Billing Fee Calculation Unit
20 Simulation Execution Unit
21 Billing Fee Presentation Unit
70 Display Unit
71 Input Unit
111 CPU
112 ROM
113 RAM
114 Non-Volatile Memory

1. An information processing device for calculating an amount of usage of a system program for converting a machining program into control signals for a machine tool, comprising:
an effective block determination unit that determines whether or not there is a code to be charged in the machining program;
a machining state determination unit that determines whether or not machining is being executed based on a machine state of the machine tool when the machining program is executed; and
a usage amount calculation unit that calculates an amount of usage of the code to be charged when the code to be charged is being executed.

2. The information processing device according to claim 1, wherein the usage amount calculation unit calculates at least one of used hour and a number of uses that the code to be charged executes the machining.

3. The information processing device according to claim 1, wherein the machining state determination unit determines whether or not the machine tool is executing the machining, and
the usage amount calculation unit calculates the amount of usage of the code to be charged in the machine tool.

4. The information processing device according to claim 1, wherein the machining state determination unit determines whether or not the machine tool is executing machining on a simulation, and
the usage amount calculation unit calculates the amount of usage of the code to be charged on the simulation.

5. The information processing device according to claim 1, wherein when the machining is in idle running, the machining state determination unit determines that the machining is not being executed.

6. The information processing device according to claim 1, wherein when registration of a condition for not charging is accepted and the machine state is interrupted under the registered condition, it is determined that no charge is necessary.

7. The information processing device according to claim 1, comprising a billing fee calculation unit that calculates a billing fee of the code to be charged based on the amount of usage of the code.

8. The information processing device according to claim 4, comprising:
a billing fee calculation unit that calculates a billing fee of the code to be charged based on the amount of usage of the code on the simulation; and
a billing fee presentation unit that presents the billing fee on the simulation to a user.

9. A storage medium for storing commands which are readable by one or more processors, the one or more processors conducting the commands to:
determine whether or not there is a code to be charged in a machining program for a machine tool;
execute the machining program;
determine whether or not machining is being executed based on a machine state of the machine tool when the machining program is executed; and
calculate an amount of usage of the code to be charged when the code to be charged is being executed.
